(19) United States
(12) Patent Application Publication
(10) Pub. No.: US 2011/0123959 A1
(43) Pub. Date: May 26, 2011

(54) Force redirecting dental core system

(76) Inventors: Robert Sicurelli, Syosset, NY (US); Samuel Masyr, Brooklyn, NY (US)

(21) Appl. No.: 12/592,347

(22) Filed: Nov. 24, 2009

(51) Int. Cl. A61C 5/11

(52) U.S. Cl. 433/221; 433/220

(57) ABSTRACT

A dental core and post system for restoration of teeth includes a core device and a dental post formed as a rod-like member extending along a central vertical axis between a coronal end and an apical end. At least one portion of the rod-like member including the apical end is configured for fixation within a root canal of a tooth for restoration. The core device is attached to or is integral with the coronal end of the dental post. At least one of the core device and dental post include an inner, low-density volume configured to limit mechanical forces communicated through the core device and dental post coaxially with the central vertical post axis after fixation.

### BACKGROUND OF THE INVENTION

The present invention broadly relates to the restoration of endodontically treated teeth, and more particularly relates to a dental core system and a dental core and post system that include core devices configured for in vivo use whereby the core devices interrupt and/or redirect mechanical energy imparted at a biting surface and normally communicated along a root within a solid dental post affixed therein in an endodontically treated tooth.

Rigid dental posts, and core systems utilizing same, are widely used to restore endodontically-treated teeth in an effort to create an adequate foundation for a final restoration. For example, rigid dental posts are fixed to the endodontically treated root, to a crown, to an onlay or to a fixed partial denture abutment, etc. Generally, a dental post or dowel is provided, i.e., fixed in the cleaned canal for retention and lateral and vertical stability of the restoration. Core material maintains the post in position, and provides further foundation support for the crown, onlay, etc. The core or core material is found above the cement-enamel junction in the crown portion of the restoration, while the post or dowel is located within the endodontically treated canal.

Two general types of post and core systems are known: prefabricated, e.g., made from metal or fibre reinforced composites and custom, e.g., cast metal. Prefabricated posts require a core to be attached to it in vivo relying on minimal adhesion and mechanical attachment of the core to the post. Metal custom cast posts have the core part attached to the post component as part of the casting. In both of these examples there is a direct uninterrupted path for a mechanical, vibratory or other stimulus to travel directly through the core and down the center of the post which is attached to the center of the root.

Several significant problems are encountered in restoring endodontically treated teeth, which typically require such treatment after compromise from trauma or neglect. For example, root canal therapy and refinement of the root canal results in a mechanical weakening of the tooth. Once the pulp including blood supply is removed from the tooth's root canal some researchers have demonstrated that the tooth over time becomes more brittle, and is more susceptible to fracture. Moreover the root canal process itself machines away the natural protective “dome” or roof of the pulp chamber of the tooth that housed low-density tissue and maintained rigidity of the natural tooth while transferring mechanical and other stimuli laterally away from the center of the root.

Endodontically treated teeth are restored with a rebar post or dowel, i.e., dental post. Due to the post's inherent high density solid structure, it has an effect of transmitting mechanical forces striking the tooth's occlusal surface along its length. In addition to communicating forces, the inherent solid nature also responds to mechanical energy striking the tooth at its occlusal end in what is known as a wedge effect. The wedge effect is a response resulting from the presence of solid post in the tooth or root center, tending to concentrate stresses and downwardly directed forces induced during normal mastication, resulting in tooth fracture.

Cailleteau, J., et al., A Comparison of Intracanal Stresses in a Post Restored Tooth Utilizing the Finite Element Method, Journal of Endodontics, Vol. 18, No. 11, November 1992, pp. 540-544, report that placement of a rigid post within a tooth alters the pattern of stress along the root canal as compared with an intact tooth. Instead of strengthening the tooth, the inserted post stiffens the coronal posted section and shifts the flexure point apically. This affects stiffening, causing the non-posted apical portions to deform at the “lost” apex, resulting in a stress increase in the proximate canal wall. Because maximum bending stresses occur in connection with the apex of the post, any inclusions or defects within the canal wall (dentin) proximate the apical end creates stress concentrations that increase the risk of fatigue crack formation. Defects and microfractures introduced during endodontic treatment and post access preparation could become areas contributing to stress concentrations and ultimate tooth loss.

This is exacerbated in view of the fact that traditional dental posts and cores posses the same mechanical properties, e.g. modulus of elasticity, from one end to the other, whether they are metals, metal alloys, or fibre reinforced plastics (FRPs). Even anisotropic FRPs have one singular and inherent modulus of elasticity for a dynamic force and the angle of that force applied because the post is solid and continuous from apical end into the core.

Various efforts are known to reduce the stresses caused by post and core system treatment, such as described by Cailleteau. For example, German Patent No. DE 3643219 to Weisskircher discloses a post comprising an elastic wire pin with plurality of flexible, radially extending fins along its length. The pin shows a high degree of elasticity due to its wirelike form so that it more readily adheres to the shape of the root canal. But like the prior art, the Weisskircher pin and fins are fixed against the wall of the root canal, and so acts as an energy transmitter communicating stresses and forces into the root.

### SUMMARY OF THE INVENTION

The instant invention provides a dental core and post system and a dental core system, each of which overcomes the shortcomings of conventional dental post and core systems.

The inventive dental post and core system and dental core system of the invention include core devices that attach to or are integrally part of posts affixed to a treated tooth, acting to interrupt and/or redistribute downwardly communicated forces that might normally travel along the dental post and fracture a tooth remainder.

Put another way, by fixing an inventive core device or core and post device in an endodontically treated tooth, axial and near axial forces applied during normal chewing are not transferred along the tooth central axis towards the root as they normally would be in the presence of a conventional solid dental post or dowel. The normal downward occlusal-generated forces are interrupted and/or redirected away from the central axis for absorption in lateral tissue and/or bone, reducing a likelihood of fracture.

As mentioned above, in traditionally restored endodontically treated teeth, the lost volume of the tooth's chamber area is replaced by a solid dowel that is attached to a sold core. In natural teeth the pulpal chamber contains an artery, nerve and vein all composed of low-density tissues, essentially an organ. The inner surface of the pulpal chambers resembles a geodesic dome, and is made of dentin. This natural structure is machined away during root canal treatment. The inventive systems provide a biologically correct replacement for missing tooth structures removed during the root canal therapy procedure, whereby treatment with same results in an interruption and/or improved distribution of forces and stresses away from the root center in which the dental post resides, by changing the force vector, i.e., the direction of biting forces induced in the treated tooth.

In an embodiment, the novel core device and novel core and post device include inner low-density inner volume portions positioned centrally that replace or mimic the form and function of the missing tooth “organ” in an endodontically-treated tooth. That is, each core device and each core and post device include a low-density inner volume or center through which the central root or post axis passes. This low density inner volume interrupts and/or redirects forces away from the root center, like an untreated vital tooth. The pre-existing qualities and functions of the natural vital tooth prior to endodontic treatment are truly restored from the inside out; occlusal forces are interrupted and deflected away from the central canal of the root, as they would be before the tooth was compromised, i.e., reamed, cleaned, irrigated and obturated.

Low-density volume, as used herein should be understood to mean that the net density of the low-density volume is lower than the density similarly located volume in traditional prefabricated devices. Low-density material has a lower density than tooth structure and a lower density of traditional metal alloys used in dentistry. For example, a low density material as used herein should have a density value in grams per cubic centimetre (g/cu. cm) in a range between 0.0 and 2.05. This range includes materials such as bonding agents, cements, resins, impression materials, monomers, pit and fissure sealant, some composite resins, silicate, vitreous carbon and air. For example, Silux enamel bond (1.20 g/cu. cm) is a low-density bonding agent. Cements can be low density including calcium hydroxide, e.g., Dycal (1.91 g/cu. cm), dentin cement (2.02 g/cu. cm), Resin, for example, CBA 9080 (2.02 g/cu. cm), unmodified ZOE, e.g., Cavitec (2.05 g/cu. cm).

Low density impression materials (polymerized) include polyether, e.g., Impregum (1.06 g/cu. cm), silicone (addition), e.g., Baysilex (1.37 g/cu. cm), Provil medium (1.40 g/cu. cm), high (1.43 g/cu. cm). Low density monomers (crown-and-bridge resins) include methyl methacrylate (0.9374 g/cu. cm), ethylene glycol dimethacrylate (1.055 g/cu. cm), 1,3-butylene glycol dimethacrylate (1.02 g/cu. cm), triethylene glycol dimethacrylate (1.072 g/cu. cm) and low density pit and fissure sealants include Delton (1.23 g/cu. cm). Low density restorative materials include composite resin, e.g., all-purpose heliomolar radiopaque (1.84 g/cu. cm), anterior Silux Plus (1.61 g/cu. cm) and Silicate improved filling, e.g., porcelain (2.01 g/cu. cm). Low density materials further include tooth structures such as cementum (2.03 g/cu. cm), vitreous carbon (1.47 g/cu. cm) and water (1.00 g/cu. cm).

In the embodiment, the core device comprises a hollow, semi-spherical high-density shell. The shell is configured as a supporting dome or crown for fixation to a coronal portion of a dental post or dowel. A vertical axis of the core device/post passes through the hollow, albeit low density inner volume. Because of its hollow nature, vertical or downward traveling forces and energy resulting from occlusal contact cannot pass directly through the core device along the vertical axis, but are interrupted and redirected so they do not pass through the core device to the top of the post. Put another way, the low-density discontinuity disrupts the downward flow of mechanical energy, preventing damage to the root from same downwardly directed forces and or downward push of the post.

The hollow core device may comprise a dental core system, wherein the core device is configured to be affixed to the coronal portion of the dental post in vivo.

The hollow or low-density dome (i.e., core device) or hollowed coronal post portion may be formed in shapes that correspond to a space for which treatment needs to cover. For example, a tooth for restoration might have 50% of its dome or crown structure remaining, such that full core device might not fit. The invention addresses this issue in a core system comprising a core device sized or shaped as a half moon or quarter moon.

In an alternative embodiment, the core device may be manufactured in such a way that it is integrally part of a dental post. In an alternative embodiment to such a dental core and post system, the integrally formed dental post may further include an inner low density volume that is contiguous with the inner low density volume of the core device. That is, both the core device and the dental post may comprise a hollow or low-density portion. In either case, at least a portion of the dental post is cemented into the root, or tooth remainder.

In another embodiment of the dental core system, and the dental core and post system, the core device is arranged with splines or ribs that extend away from a high density portion of the core device, e.g., shell, to effect a redirection of downward induced occlusal forces. Preferably the affixed splines or ribs extend from the core device and are affixed to a remainder portion of the tooth structure, which thereafter acts as a sink to redirected mechanical energy. While the splines act to redirect the mechanical energy away from the central axis (of the core device and/or post device), regardless of whether the core device comprises a low density inner volume as described above, it is preferable that the core device to which the splines are connected includes the low density inner volume. In that way, there are two mechanisms which act to redirect forces traveling downward from occlusal contact.

Moreover, various embodiments of prefabricated core devices are formed to fit tighter spaces, e.g., tooth remains. For example, a dental core device embodiment includes that splines extending down from the core device mimic ribs extending from a ferrule of an umbrella. Upon insertion, the splines or ribs are spread out to open partially. That is, the umbrella-like core device could be cranked open or closed in vivo depending on the volume of tooth structure lost. The inventive core device and its splines may be assembled in vivo, and attached to a traditional post. For that matter, the core device may comprise just the splines or ribs, which are fixed both to the post and to a tooth remainder to form a solid path by which mechanical energy is directed away from the post into the remainder tooth structure or dentin.

Preferably, the core device includes some kind of mechanism at its end opposite its occlusal end to facilitate attachment to a dental post. For example, the core device can be configured with an opening into which the post may be inserted, e.g., so the coronal post portion snaps in. In this case, post might be manufactured with ball-like top at its coronal end, where the ball-like top snaps or is otherwise fixed into a complementary space in the core device. Such novel core device can be part of a core system, sold for use with conventional dental posts, or as a part of a dental post and core system, where the core device is manufactured as an integral part with the dental post. For that matter, there may be one or more through holes in the sides or apical center of the attachment or coupling means, to allow for low density material or adhesive to flow through it and envelope the dental post in vivo, or to flow into an opening or inner volume in the coronal end of a dental post comprising one embodiment of a dental core and post system, described in greater detail below.

An alternative attachment means for attaching a core device to a dental post is configured with a cylindrical portion to slide over and attach the coronal end of the dental post in vivo. The inside diameter of the cylindrical portion is larger that an outside diameter of the dental post. This cylindrical portion is preferably configured as a crimpable cylindrical shell in order to securely attach to the coronal post. The attachment means, however, is not limited to attachment merely by crimping. The attachment means may be attached to the dental post with a traditional low and/or high density adhesive, with or without crimping. Another variation of this attachment means is construction where an inside diameter of the cylindrical portion has a slight taper to mate with that of the coronal aspect of the post. In all cases this means of attachments functions to discontinue, redirect and dissipate energy away from the center of the canal acting as a buffer.

The core device may be manufactured so that the attachment means is integral with it, for example, in an extrusion process or an injection molding process. In that way, the attachment means portion of the core device is configured to extend out from a hard shell of the core device for attachment to the dental post. Alternatively, the attachment coupling means may be constructed as a separate device configured to be fixed to the apical end of the core device using an FDA approved adhesive at manufacture, or constructed as a separate standalone device for connection both the core device and the dental post at use.

Alternatively, the core device or dome may comprise a wire frame or cage, defining its shape and a portion of the core device structure to contact the dentin. The higher density wire frame provides a skeleton to house the low-density material within. As such, force striking the top or occlusal portion of the core device would travel along the shell, i.e., cage and make contact with and communicate into the dentin rather than pass along the central core/post axis. Preferably, such a cage-like core device (or dome structure) comprises a low-density volume. The low-density volume, whether comprising a core device attached to or integral with a coronal end portion of a dental post, with or without an inner volume or post channel, preferably includes a low-density material, e.g., air, which defines the density of the low-density volume.

Alternatively, the novel core and post system may comprise only a wire-formed core device and top post portion, forming a hollow inner volume extending contiguously from the core device into the top portion of the post device. This low-density inner volume is filled with a low density material, e.g., air or resin, and provides the low-density discontinuity along the vertical root canal axis, and redirects forces via the wire frame. The redirected forces are absorbed by the dentin surrounding the canal space and/or the residual walls of the tooth. This significantly reduces stresses including the above-mentioned wedging effect, and therefore, likelihood of tooth fracture. That is, damaging and material fatiguing forces are redirected away from the center of the root, with respect to the tooth axis, which would be inherently destructive.

### DESCRIPTION OF THE DRAWING FIGURES

Aspects of the disclosed technology will become apparent upon reading the following detailed description and upon reference to the accompanying drawings in which, like references may indicate similar elements:

FIG. 1A depicts one embodiment of a dental core and post system of the invention;

FIG. 1B depicts another embodiment of a dental core and post system of the invention;

FIG. 1C depicts a variation of the FIG. 1A embodiment;

FIG. 1D depicts a variation on the FIG. 1B embodiment;

FIG. 2 depicts another embodiment of a dental core and post system of the invention;

FIG. 3A depicts another embodiment of a dental core and post system of the invention;

FIG. 3B depicts another embodiment of a dental core and post system of the invention;

FIG. 4A depicts one embodiment of a dental core device of the invention;

FIGS. 4B-4F depict alternative embodiments of core devices of the invention;

FIGS. 5A and 5B together depict another embodiment of a dental core system of the invention; and

FIGS. 6A-6D together depict another embodiment of a dental core system of the invention.

### DETAILED DESCRIPTION OF THE INVENTION

The following is a detailed description of example embodiments of the disclosed technology depicted in the accompanying drawings. The example embodiments are in such detail as to clearly communicate the disclosed technology. However, the amount of detail offered is not intended to limit the anticipated variations of embodiments. On the contrary, the intention is to cover all modifications, equivalents, and alternatives falling within the spirit and scope of the invention, as defined by the appended claims. The descriptions below are designed to make such embodiments obvious to a person of ordinary skill in the art.

Natural, vital human teeth have only low-density soft tissues in the chamber and root, i.e., pulp with blood vessels and nerve tissue. The natural top of the chamber, or crown, comprises a layer of enamel enveloping a dentin shell about the upper chamber with pulp, etc. The natural crown and root so formed is designed to deflect and redistribute mechanical energy and/or forces traveling down the tooth resulting from occlusal contact. That is, biting forces do not normally travel along or within the root canal of a vital tooth. The same is not true, however, with endodontically treated teeth restored with dowels and traditional core materials, whether prefabricated or custom cast.

As mentioned, traditional dental posts and core devices are solid and fixed to the internal surfaces to the center of the tooth's root, forming a contiguous solid structure. Such contiguous solid structure begins at the occlusal end of the tooth and extends to the apex of the root. Because prefabricated dental posts used with conventional core systems to fill the missing chamber and root are constructed of solid metal, fibre reinforced composites or plastics (i.e., high density materials), they cannot replace the function of the low density soft tissue present in vital teeth, pre-restoration. That is, the removed low density tissue, and therefore, low density volume results in marked inability of the restored tooth to shield the canal space from operating act a pathway to external forces traveling down and substantially along the tooth/canal center, i.e., occlusal or chewing forces.

The core devices of this invention are designed to mimic the natural functioning of a crown, chamber and root that have not been compromised in a tooth that has been compromised by endodontic treatment. The invention may comprise a dome or core device affixed to and/or formed with a vertically extending post structure, where at least one of the dome/core device and post structure is configured to include a low-density volume. Preferably, the low-density volume is filled with a low-density biocompatible material, such as air, settable foam, or low-density resin.

The low density volume acts to inhibit and/or forces traveling along the dental post in a restored tooth within which the core device is used. The redirected forces are dispersed and absorbed into the dentin and/or residual enamel, the soft tissue surrounding the crown and the bone surrounding the root, avoiding any solid post or dowel fixed therein. That is, this low-density character of the inner core device volume mimics the natural vital tooth construction to buffer or interrupt and redirects biting forces away from the affixed post.

In an embodiment, the dome or core device may comprise a spherical or semi-spherical structure with an inner volume or center that is hollow or semi hollow, i.e., air filled. Such inner volume also may be pre-filled with a low density material at a time of manufacture or in vivo by the dental practitioner at the time of treatment including placement or fixation of at least part of a dental post into a root canal. In the latter case, the core device will include an opening, preferably at the top, to facilitate filling and or fixation of the device to the root (where the low-density material is a dental adhesive or cement). A vent is includes to allow pressure release at filling where needed, which filling is typically carried out with a syringe-like device.

Alternatively, a dental core device may be configured to snap on to a traditional dental post or dowel, may include a recess in the bottom into which a coronal end of the dowel extends, or may include a cylindrical member extending down from the apical end of the device which surrounds some portion of a top or occlusal end of the dowel. Other core devices may be designed merely to contact the occlusal post end, where a device portion is fixed to a tooth remainder either directly, or though one or more splines or ribs. In one embodiment, a diameter of the core device which contacts the tooth remainder may be adjusted radially where it will create a continuous mechanical path away from the post device to which it is in physical contact.

This mechanical path created by the core device will direct or redirect vertical or and angular off-vertical forces away from the root center. For that matter, the core device may be connected to a conventional dental post using any means known in the art for making such connection, and may be attached at any point along the vertical length of the dental post, while preferably at its occlusal end. Depending on the tooth, and the intent of the dental professional attaching the post and core device, multiple splines may be attached to the post and fixed to the tooth structure at various radial positions relative a central vertical post axis.

The dental core system and dental core and post system, in addition to a core device such as described, may further comprise a dental post with an open lumen (i.e., inner volume) configured along some portion of its length, preferably along a top portion proximate its occlusal end. This inner volume, however, is not limited to be about ⅓ of the post length, but may be greater or lesser that ⅓ as long as it does not extend completely to the apical post end. Preferably, the post inner volume or lumen is contiguous with an open inner volume of the core device attached or manufactured integrally thereto. The inner volume(s) of the core device and/or post comprise low-density material, either manufacturer filled of filled at fixation by the dental practitioner, where the core device and/or post would include a via though the post shell or wall to allow for in vivo filling with the low-density material.

In an alternative embodiment, the core device includes a plate or disk-like structure that is large enough to cover an open lumen or low-density volume of the dental post. The plate is manufactured with a via through which the dental post is passed or slid through, and which functions to limit lateral movement of the post when striking forces by transferring energy to the residual tooth structure surrounding inner volume portion. The plate could be attached to the dental post rigidly at manufacture, or be available as a separate plate or disc for fixation to the post at the time of treatment. For that matter one or more additional plates could be positioned between the plate and coronal end of the dental post.

Moreover, while each of the core device and core device with dental post are preferably integrally formed as one piece (for example, the inner volume and solid lower portion of the dental post portion), the components also may be formed separately and made of different materials. For example, the core device or dome and post portion surrounding its inner volume may comprise a hard plastic, metal cast or wire cage shell, the lower post portion may comprise a solid metal or fibre-reinforced composite, without limitation.

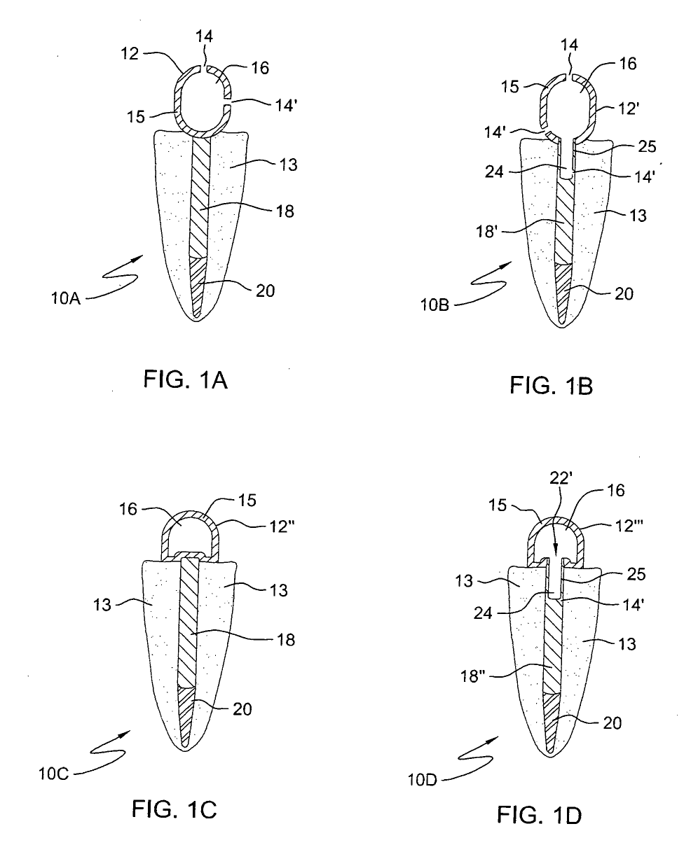

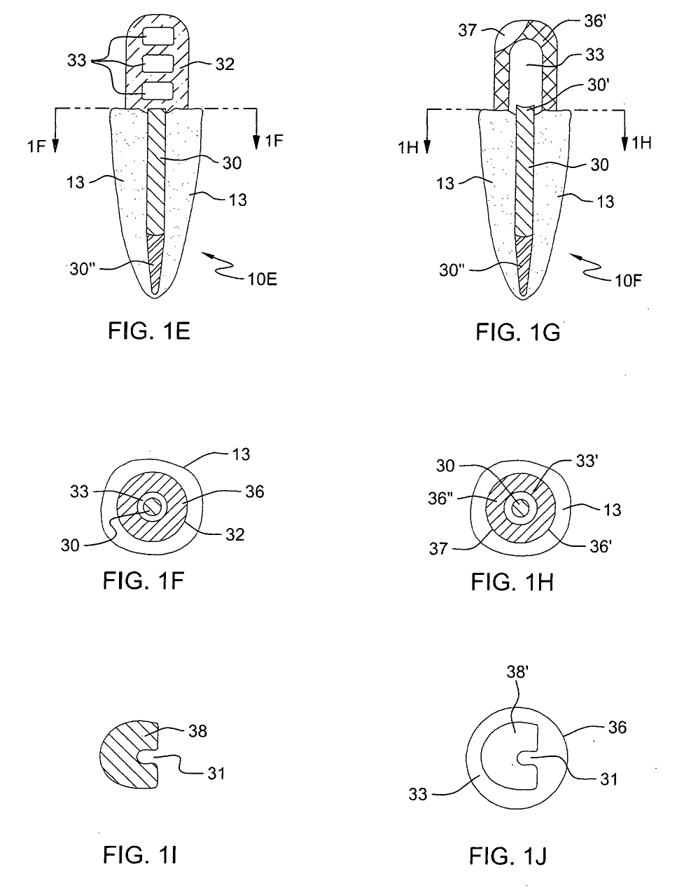

FIG. 1A depicts one embodiment of a dental core and post system (10A) that comprises a spherical core device (12) formed with an opening (14) in a shell (15) to enable a hollow center (16) of the core device surrounded by the shell (15) to be filled with a very low-density settable material at fixation. Shell (15) preferably comprises a high density material, in order to maintain its shape, i.e., the shape of the inner, low density volume. While not shown in the figure, the core device (12) may be filled through opening (14) of shell (15) using any means known to the skilled artisan, for example, a syringe-type tip through which the low density material will flow. Preferably a vent (14′) is included in the shell (15) to release pressure as the core device is filled.

And while the core device (12) is depicted as spherical, the core device is not intended to be limited to a particular shape as long as at least some portion of an inner volume is found in a path from its top to bottom along its axial center in order that it prevent communication of vertical or downward traveling forces and energy resulting from occlusal contact. For that matter, while the core device (12) is shown attached to a post (18), the core device and post may be separate devices connected at the time of treatment. The core device (12) may be connected to post (18) using any means known to the skilled artisan, for example by including an indent to receive a coronal end of the dental post, by adhesive or cement, crimping, etc.

That is, the FIG. 1A dental core and post system (10A) further comprises a solid vertical post member or dowel (18) and a lower post portion (20). The dental post (18) is shown surrounded by tooth remainder or root material (13), e.g., dentin, where some portion of the outer shell of the core device contacts and/or is affixed to the tooth remainder. Upon fixation filling the inner volume of core device (12), the material is set/cured and openings (14; 14′) in shell (15) are sealed. It should be noted that the shape of core device (12), the dimension of the inner volume (16), the size and location of the openings (14; 14′) in shell (15), the length, diameter and taper of the vertical post member (18) and any attached lower post portion (20), or alternatively, gutta percha, may vary without departing from the spirit or essence of the invention.

That is, the only requirement is that the core device of the dental core and post system include a low-density inner volume to act as a discontinuity between at high density crown surface and a high density post to redirect or inhibit downward communication of mechanical energy generated by occlusal or biting forces passing along the vertical center of the post/root canal after fixation. This discontinuity between the core device and post further acts to prevent forces that might act to dislodge and downwardly move a solid post positioned directly under the core device, which forces might otherwise split or fracture the tooth remainder or canal.

FIG. 1B depicts a dental core and post system (10B) that represents a variation on the FIG. 1A embodiment. That is, dental core and post system (10B) includes an opening at a lower portion of a shell (15) to facilitate fluid communication between the inner volume of the core device (12′) with an inner volume or lumen (24) included that is part of the dental post positioned above the solid vertical post member portion (18′). Inner volume (24) of the dental post is surrounded by shell portion (25). After fixation in vivo, filling with low-density material, and sealing, the low-density inner volume of core device (12′) and the low-density inner volume or lumen (24) forming an occlusal end of solid vertical post (18′) together act to prevent the communication of downwardly flow of mechanical energy initiated by biting contact through the axial center of the tooth, including the solid post portion. As, such the wedge effect is substantially minimized. Vents (14′) are shown in both the core device shell structure (15) surrounding the low-density inner volume and the shell portion (25) enclosing the post lumen (24).

FIG. 1C depicts a dental core and post system (10C) that represents a variation of the FIG. 1A embodiment. That is, dental core and post system (10C) includes a core device (12″) with an inner volume (16) surrounded by shell (15) and pre-filled with a low-density, preferably biocompatible, material. There is no need for an opening (14) or vent (14′) because dental post and core system (10C) is pre-filled. The core device (12″) is shown seated upon or otherwise contacted with remainder tooth or root structure (13), and further contacting or attached to an occlusal end of post (18).

FIG. 1D depicts a dental core and post system (10D) that represents a variation of the FIG. 1C embodiment. Dental core and post system (10D) includes a core device (12′″) with inner volume (16) surrounded by shell (15), which is pre-filled with the low-density material. Post device (18″) includes an inner shell portion (25) surrounding an inner volume or lumen (24) of vertical post portion (18″). An opening (22′) in shell (15) and interfaces with an opening in shell (25) of inner volume (24), whereby the respective volumes merge to form a contiguous large inner volume in the core and post system. Like core system (10C), there is no need for an opening (14) because dental core and post system (10C) is pre-filled.

As a means for attaching a core device to a dental post, the invention includes an attachment means configured with a cylindrical portion to slide over and attach the coronal end of the dental post in vivo. The inside diameter of the cylindrical, apical end of the attachment means is larger that an outside diameter of the dental post. This cylindrical portion is preferably configured as a crimpable cylindrical shell in order to securely attach it to the coronal post end. The attachment means, however, is not limited to attachment merely by crimping. Another variation of this attachment means is constructing the inside diameter of the cylindrical portion to have a slight taper to mate with that of the coronal aspect of the post.

The attachment means may be attached to the dental post with a traditional low and/or high density adhesive, with or without crimping. For that matter, there may be one or more through holes in the sides or apical center of the attachment means to allow for low density material or adhesive to flow through it and envelope the dental post in vivo, or to flow into an opening and inner volume of a coronal end of a dental post. In all cases the means of attachment functions to discontinue, redirect and dissipate energy away from the center of the canal acting as a buffer.

The core device may be manufactured so that the attaching means and cylindrical shell is integral with it, for example, in an extrusion process or an injection molding process. In this case, the attachment means is configured to extend out from a hard shell of the core device to form a cylindrical shell to attach to the dental post. Alternatively, the attachment means may be constructed as a separate device configured to be fixed to the apical end of the core device using an FDA approved class 1 dental adhesive at manufacture, or constructed as a separate standalone device for connection both the core device and the dental post at use.

In another embodiment, the novel post included with the novel core and post system is formed entirely of composite material the physical properties of which are modified along its length, including the core device portion. For example, the properties of the post material are modified by selectively manipulating the composite material found in the post inner volume (24) and the core device inner volume (16). Where the dental post and core system is pre-formed, for example, by injection molding, multiple molding steps could be used to impart variable shapes and mechanical properties to the posts by layering and staging.

FIG. 1E depicts another embodiment of a dental core and post system 10E, where FIG. 1F shows a top cross-sectional view of same at an interface between a core device (32) and post (30). Dental post (30) is shown positioned in a canal within root or dentin material (13) comprising a tooth remainder, which includes a lower portion (30″), for example, gutta percha. The figure highlights an internal volume (33) of the core device (32), acting as an upper coronal portion of the dental core and post system post 10E. Core device (32) is shown to be contiguously disposed upon a rim or ridge of the remaining tooth material or dentin (13). The downward looking cross-sectional view of FIG. 1F depicts the coronal portion or tip of the post (30), upon which is disposed core device (32). The core device (32) is shown to comprise shell structure (36) surrounding low density volume (33). The shell (36) sits upon or is attached to partially obscured tooth remainder or upper most portion of dentin (34).

FIG. 1G depicts another embodiment of a dental core and post system of the invention, where FIG. 1H shows a downward looking cross-sectional view of same. Dental post (30) is shown positioned in a canal within root or dentin material (13), including a lower portion (30″), for example, gutta percha, and an upper coronal portion (30′) extending only partly into core device (36′). Upper coronal portion (30′) of the dental post is shown encased in a core device (36′), just below inner space (33). Core device (36″) is disposed (at least partly) upon a rim or ridge of remaining tooth material or dentin (13). The cross sectional view of FIG. 1H depicts the coronal portion or tip of the dental post (30′). The figure highlights that low-density inner volume (33) is bounded by a cage-like shell structure (36″), upon which is formed an outer skin or surface (37), partially shown. The core device (36′), inner volume (33), shell structure (36″), skin (37) and inner volume (33) sit upon the dentin or tooth remainder (13), and receive a small part of the length of post (3).

FIG. 1I depicts an embodiment of a dental post (38) seen in cross section, including a slot or inner channel (31). Slot or inner channel (31) preferably is positioned at the top or coronal end of the dental post (38), and is configured to receive a protruding member of a core device (not shown), for engagement with the slot to attach the core device thereto. FIG. 1J depicts a modified or alternative version of the FIG. 1I dental post, which is hollow at least at a top or coronal end as shown. For that matter, dental post (38′) is shown surrounded in cross section by an inner volume (33) of a core device (36), comprising a low-density material, e.g., cement, acting to attach the core device to the dental post (38′).

The reader should note that while FIGS. 1I and 1J depict that the dental posts (38, 38′) include the slot to facilitate attachment of a core device, or low-density material, the invention is not limited to such an arrangement for connecting or attaching the post and core device. That is, the core device may be formed with an inner channel or slot device, wherein the dental post would then comprise a protruding portion to mate therewith without deviating from the scope or spirit of the invention.

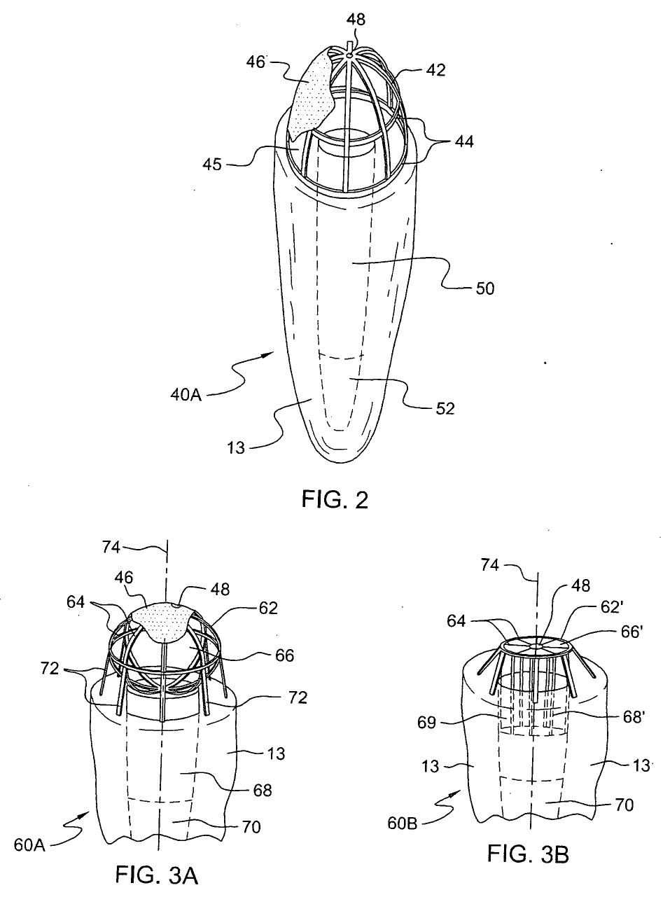

FIG. 2 depicts an alternative dental core and post system 40A configured in accordance with the invention. Dental core and post system 40A includes core device (45) that comprises a frame structure configured from vertical struts or wires (42), as shown. Rings (44) are included to provide structural integrity to cage-like frame or shell structure (45), defining an outer boundary of an inner volume (33). The core device (45) of dental core and post system 40A has an “egg beater” appearance. The inner volume surrounded by the cage-like frame or shell structure (45) is intended to be filled in vivo, so includes a skin, or material containing layer (46). The containing layer (46) may be adhered to the frame (rings (44) and wires (42)), using known processes, such as injection molding, or may simply comprise a sleeve.

The core device (45) is configured to sit upon a remainder tooth portion (13), shown surrounding a dental post (50) with an attached lower portion (52). Such core device (45) design may appear as a fully open, operating parachute, with the substantial portion of the post between the core device and terminus comprising converging extensions. Alternatively, the core device may be solid comprising materials such as dental metals, plastics, reinforced plastics, or composites or combinations of materials, and the middle vertical post length may comprise the low-density material, or to be filled with same at the time of implantation to facilitate interruption of forces directed therethrough.

To fill the skin-enclosed volume defined by frame (45) and skin (46), an opening (48) is maintained at top ring (44). A low-density, preferably biocompatible material is injected into the inner volume, as well as any further material required to set/cure the low-density material. The opening is then sealed by the material when it sets. Preferably, a vent is included to release pressure as the material is filled. In a variation, the dental core and post system 40A may include that the core device (45) is pre-filled with the low-density material during its manufacture, obviating a need to maintain an opening (48) and/or vents. The skin could be removable and used only to compress the inner low-density material in vivo.

The core device construction is such that it communicates downward forces, if at all, at an acute angle relative the root axis away from the attached post and into the dentin or remainder tooth material. The acute angle is preferably greater than 15 degrees but less than 75 degrees, the latter limitation intended to minimize radial forces which might fracture horizontally. Moreover, while each of the vertical post lengths are depicted as tapered, so far, they may be cylindrical with a constant radius extending the along an axial length of the post without deviating from the spirit or essence of the invention.

Alternatively, the core device may be configured with detents or undercut areas to lock in cement. That is, the core device itself could contain holes or perforations in its outer surface to increase retention of cement and reduce mass. For that matter, the outer concave viewing from underneath looking up from the canal. Surfaces could also contain irregularities to provide extra surface area for bonding adhesive or core material. Various surface treatment materials such as, but not limited to, silane may be optionally used to enhance the bonding of restorative material.

In another embodiment, the internal aspect of the core device and the mid vertical post extension into the tube area where the extensions converge could be left hollow or filled in vivo using different materials to achieve different mechanical properties. These fillers could be known dental cements or new creations that match pulpal tissues in density and other properties. The result is a static device with multiple mechanical properties because it was constructed from at least two types of materials. The hollow area could be changed in volume by adding more or less filler of different properties. Also, another embodiment contains a stiffener rod that extends down through a port at the top of the core device and through the hollow into the root aspect. The length and extension and properties of this rod could be changed to the clinician's requirements.

FIG. 3A depicts another dental core and post system 60A, configured in accordance with the invention. Dental core and post system 60A comprises a core device (62) frame constructed from wires (44) in a cage-like form with an opening (48) in a skin or outer layer (46). The core device is filled with a low-density material through opening (48) with any means known to the skilled artisan. Preferably, a vent is included in a shell of the core device to release pressure as it is filled. After set/curing, the openings are sealed. In a variation, dental post and core system (60A) may be pre-filled with low-density material, obviating a need for injection and curing by the dental practitioner, and a need for openings (48). The core device is attached in vivo, or formed as a single contiguous unit with a post (68). Post (68) is shown to include a second, middle portion (70). The post and middle portion may comprise metal, fibreglass, plastic, composite, rubber, gutta percha or like material. A modification of this embodiment includes a sliding or rigidly attached plate that rests on the outer rim of tooth structure surrounding the canal opening.

The core device or upper post portion (62) is configured with extensions or splines (72) extending downward and radially at an acute angle to the post axis (74). These splines or extensions (72) are configured to be fixed to the remaining tooth or dentin (13) to better support the dental core and post system 60A, and to better communicate and disperse downwardly communicated energy and vibrations resulting from biting (occlusal) contact with the tooth away from the post and/or root axis (74). Dental core and post system 60A, therefore, not only includes the discontinuity of the low-density volume (66) comprising core device (62), but also these splines to redirect the downward forces. For that matter, the splines or extensions (72) are preferably frangible, so the dental practitioner can readily adjust their length, at their various locations about the post outer circumference. The characteristic is advantageous in order to allow the dental practitioner to accommodate the shape of the remaining tooth structure into which the dental core and post system 60A is inserted.

FIG. 3B depicts a dental core and post system 60B, that is a variation of the FIG. 3A embodiment. As is shown, core device (62′) comprises a small cylindrical structure, as shown, with opening (48), enclosing a smaller volume (66′) as compared to the core device (62) of dental core and post system 60A. The mid vertical post portion (68′) comprises a cage-like structure formed of struts and/or wires (64) (skin or outer surface not shown), which allows an inner volume (69) to be filled with low-density material. Dental core and post system 60B includes extensions or splines (72) to further transfer, redirect or communicate downwardly directed forces out and away from the vertical axis of the root canal/post.

Although the embodiment described are depicted as comprising one contiguous piece, whether formed as one piece or fixedly and contiguously attached together, the invention is not limited to such a design. That is, it is possible to prefabricate the dental posts in sections, for example, the core device, the mid vertical post section/portion and the post end section/portion, where each of the sections are formed so that they are readily connected together, for example, so they snap together. For example, the connecting portions may include detent means, snaps or may be formed for a friction fit. The connecting portions might also be fabricated to screw or lock into extension radii such as rings to fit into the end dowel/post piece. Such in vivo assembly affords the use of multi variable mix and match sizes.

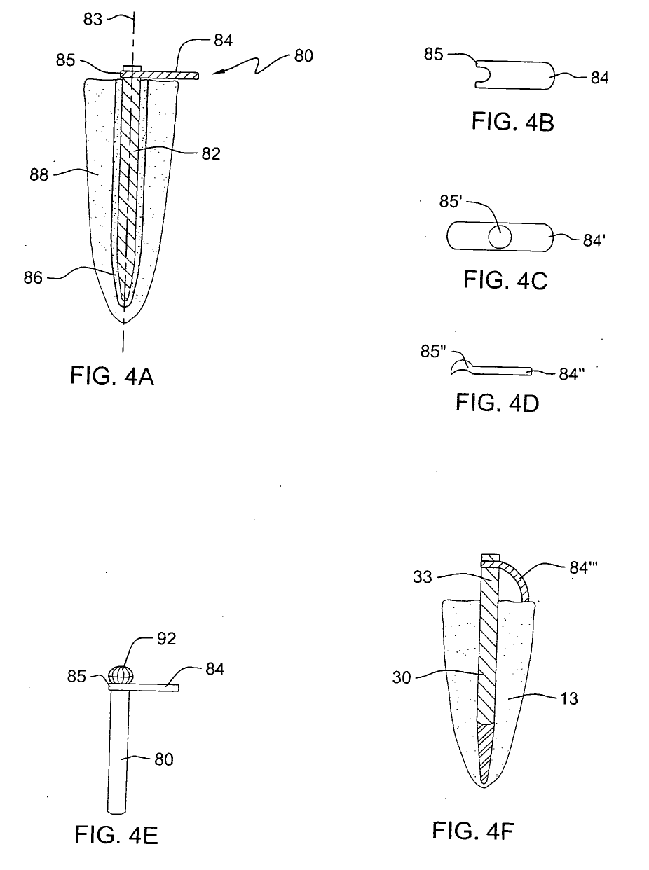

FIG. 4A depicts a dental core system comprising a core device (80), configured as a snap on spline or rib to attach to a dental post or dowel (84). The novel core device (84) is shown after affixation to dental post (82), as system (80). The core device affixes to the dental post at a snap-on end (85), which dental post (82) is shown within a root portion (86) of a tooth remainder surrounded by dentin (88). Another end of the snap-on core device (84) (which is shown separately in FIG. 4b), attaches to or otherwise contacts the tooth remainder or dentin. When attached to post (82) and to the tooth remainder or dentin of the treated tooth, the snap-on core device (84) acts to redirect forces traveling through the post, particularly downward in a direction of vertical axis (83), into dentin or soft tissue in which the snap-on core device is embedded or attached to by the dental practitioner.

While FIG. 4A depicts only one snap-on core device (84) attached to post (82) at snap-on end (85) and to the tooth remainder at its other end, any number of snap on core devices (84) may be attached to the post as required, in any vertical location along the post's vertical axis. Accordingly, and in the spirit of the invention the snap on core device creates an alternative path for, or discontinuity in a path of travel of mechanical, acoustic, vibratory and other energy resulting from occlusal contact. Preferably, these separate snap-on core devices are radially offset from each other about axis (83), for example, with second snap-on core device offset 90 degrees relative the first snap-on core device, a third snap-on core device offset by 180 degrees and a fourth snap-on core device offset by 270 degrees.

The skilled artisan should note, however, that such snap-on core devices are to be attached only where allowable in view of the existing remaining tooth structure. For that matter, these core device need not be “snapped-on” at all, may be fixed to the coronal end of the dental post by any means known to the skilled artisan, as long as same attachment acts to redirect mechanical energy, e.g., vibrations away from the vertical axis, which mechanical energy typically resulting from biting contact with the treated tooth that might otherwise or normally be communicated along the vertical post axis.

FIG. 4C depicts a snap-on core device (84′) that is an alternative embodiment of the snap-on core device (84) of FIGS. 4A, 4B. Snap-on Core device (84′) comprises two struts or wings extending collinearly from a center attaching portion (85′). That is, the snap-on core device (84′) is affixed to a post (82) by center attaching portion (85′), and at its ends to the tooth remainder. The ends of the core device (84′) may be attached to the tooth reminder by any means. For example, the ends may be moulded to set on a rim portion of the tooth remainder, and fixed to same as the core build-up is formed over the coronal post end and body of the core device (85′).

FIG. 4D depicts a snap-on core device (84″) that is yet another alternative embodiment of the core device (84) depicted in FIGS. 4A and 4B. snap-on core device (84″) includes an attaching portion (85″) that has a concavity to be fitted over a ball portion (not shown) of a dental post such that it may snap on and/or be other fixed to the ball portion, e.g., cement. While the snap-on core device embodiments are shown extending substantially perpendicularly out from the vertical post axis, the depictions are meant for exemplary purposes only.

An attachment means may be included for attaching a core device (e.g., a strut or rib) to a dental post, where the other device end connects to or otherwise contacts with the tooth remainder to redirect mechanical forces from the post. The attachment means is configured with a cylindrical portion at its apical end so that it will slide over and attach to the coronal end of the dental post in vivo. The inside diameter of the cylindrical portion the attachment means is larger that an outside diameter of the dental post, and is preferably crimpable to securely attach to the coronal post end. The attachment means, however, is not limited to attachment merely by crimping. The attachment means may be attached to the dental post with a traditional low and/or high density adhesive, with or without crimping.

The core device, e.g., core device 84, may be manufactured so that the attachment means is integral with it, for example, in an extrusion process or an injection molding process. Alternatively, the attachment means may be constructed as a separate device configured to be fixed to the core device using an FDA approved class 1 dental adhesive at manufacture, or constructed as a separate standalone device for connection both the core device and the dental post at use.

The snap-on core devices (84, 84″, 84″) may extend at any angle from 0 to 180 degree from the vertical post axis to contact with and/or attach to the tooth remainder, but preferably between 0 and 90 degrees, and most preferably between 10 and 80 degrees (see, for example, core device 84′″ of FIG. 4F). The struts or appendages, i.e., snap-on core devices engage an outer rim of the root or canal space at angles with the post central vertical axis between 0 and 90 where attached to the post directly. The snap-on core devices, however, are configured or manipulated to extend at about 90 degrees to the vertical post axis if used with (attached to) a core device (12, 12′, 12″, 12′″), such as described above and depicted in FIGS. 1A-1D, or, as another example, quasi-spherical and dome-like core device 92, hereinafter described with reference to FIG. 4E.

FIG. 4E depicts a strut-like core device (84) attached to a post (80) via attaching portion (85) (or other functional attaching means), upon which a second and dome-like core device (92) is attached, or positioned in a restoration. Dome-like core device (92) as shown is constructed as a wire frame, which may or may not be covered with a skin of some type of bio-compatible material. Please note that while constructed as a wire frame, dome-like core device (92) is not limited to a wire or cage-like construction, but may be constructed in any way known to the skilled artisan whereby a low-density inner volume is included. The dome-like core device (92) may be spherical, half spherical, half moon, etc., and preferably including a concavity to attach to a coronal end of a dental post, for example, a ball shaped coronal end.

The inner volume of the dome-like cage structure may be filled with a low-density material such a biocompatible foam or cement, and cured at installation, or may be manufactured to include such a low-density material. Alternatively, the dome-like core device (92) may be formed as a low-density structure without a wire cage, in a spherical shape, half moon shape, half-moon shape with a concave indentation for fixation to a post, etc. In either case, the dome-like core device (92) may be modified physically before affixing to the tooth/post to accommodate a varying shape of a remaining tooth structure.

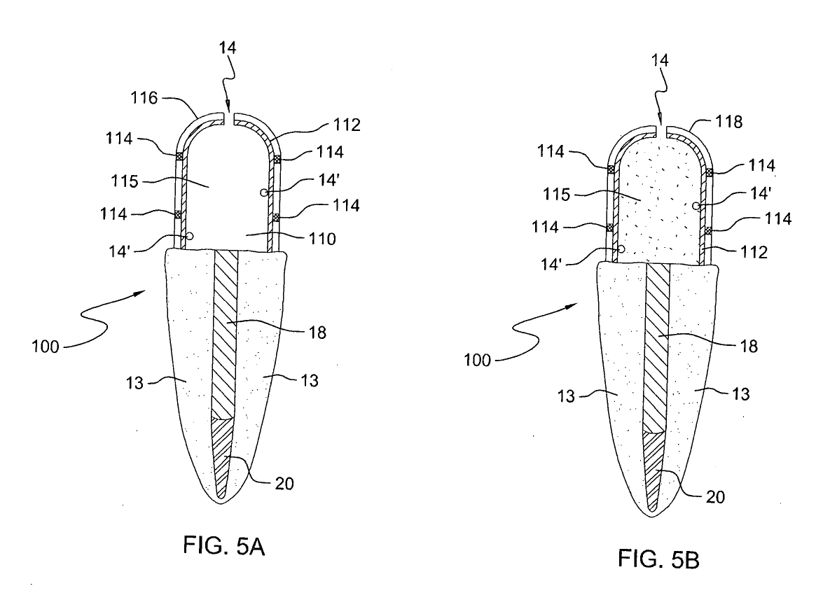

FIGS. 5A and 5B together depict another embodiment of a dental core system (100) of the invention. Dental core system (100) includes a core device (110) with an outer shell (112). The outer shell comprises a high density material. A dental post (18) is shown with both the post and gutta percha fixed within a root canal of a tooth under restoration. The core device is shown in FIGS. 5A and 5B after fixation to post (18) and a tooth remainder or dentin (13). Core device (110) comprises a hollow core or inner volume (115), a low density material fill hole (14), one or more vent holes (14′) and a plurality of skin spacers (114).

The core device is attached in vivo to tooth remainder (13) and dental post (18) at the time of treatment. A skin (116) is shown proximate shell (112), standing off from an outer surface of the shell by an amount defined by the width of skin spacers (114). After attachment, the inner volume (115) of the core device (110) is filled with a low density material (represented by the dotted texture marks in FIG. 5B) by the dental practitioner. During filling, some of the low-density material escapes from vent holes (14′) and fills the space between the outer surface of shell (112) and the skin (116). Alternatively, the space between the outer surface of shell (112) and skin (116) may be filled directly at an opening proximate opening (14). Skin (116) may be clear. After filling, and setting, the set material provides an additional low density flashing on the outer surface of shell (112). The skin may be removed.

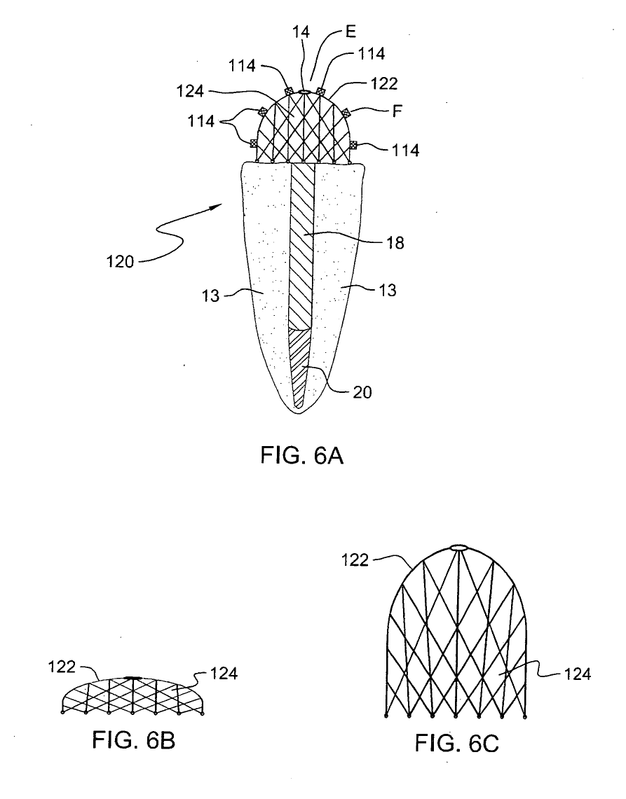

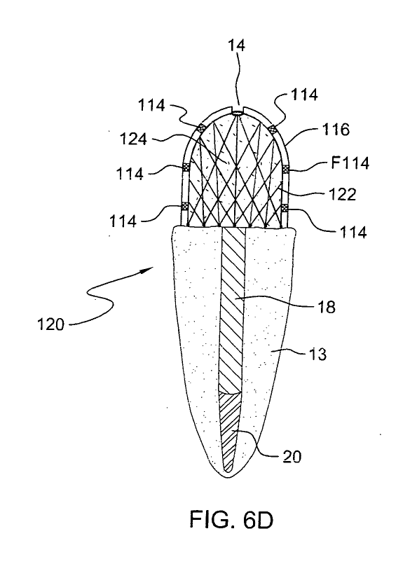

FIGS. 6A and 6B together depict another embodiment of a dental core system (120) of the invention. A dental post (18) is shown attached to the root of an endodontically treated tooth. The core device is shown in FIGS. 6A and 6D after fixation to post (18) and a tooth remainder or dentin (13). Dental core system (120) includes a core device (122) that is expandable from a collapsed position (FIG. 6B). FIG. 6C shows core device (122) in a half-expanded state, which is the same state of the core device as shown attached in FIG. 6D.

The expandable core device (122) is comprises a set of wires, strands or ribs which slide over each other to expand and contract the physical inner volume of the core device. The physical structure therefore forms a high-density shell (123), which is expandable and contractible to a desired shape/inner volume. The wires, strands or ribs may comprise metal, reinforced fiber, composites, etc. The core device (122) comprises a hollow core or inner volume (124), a low density material fill hole (14) and a plurality of skin spacers (114). The core device is attached in vivo to tooth remainder (13) and dental post (18) at the time of treatment.

In FIG. 6D, a skin (116) is shown proximate shell (123), standing off from an outer surface of shell (123) by an amount defined by the width of skin spacers (114). After attachment, the inner volume (124) of the core device (122) is filled with a low density material (represented by the dotted texture marks in FIG. 6D) by the dental practitioner. During filling, some of the low-density material escapes from the porous nature of the outer shell (123) and fills the space between the outer surface of shell and the skin (116). Alternatively, the space between the outer surface of shell (123) and skin (116) may be filled directly at an opening proximate opening (14). Skin (116) may be clear. After filling, and setting, the set material provides an additional low density flashing on the outer surface of shell (123). The skin may be removed.

Although examples of the invention have been shown and described, it would be appreciated by those skilled in the art that changes may be made in these embodiments without departing from the principles and spirit of the invention, the scope of which is defined in the following claims and their equivalents.

1. A dental core and post system for restoration of teeth, comprising:
a core system including a core device; and
a dental post comprising a rod-like member extending along a central vertical axis between a coronal end and an apical end, at least one portion of which, including the apical end, configured for fixation within a root canal of a tooth for restoration;
wherein the core device is attached to or is integral with the coronal end of the dental post and wherein at least one of the core device and dental post include an inner, low-density volume configured to limit mechanical forces communicated through the core device and dental post coaxially with the central vertical post axis, after fixation.

2. The dental core and post system as set forth in claim 1, wherein said inner, low-density volume creates a low-density discontinuity in a path through which said mechanical forces travel after fixation.

3. The dental core and post system as set forth in claim 2, wherein said core device comprises said inner, low-density volume, which is surrounded by a high-density shell defining a contour or shape of said core device.

4. The dental core and post system as set forth in claim 3, wherein said high-density shell comprises a cage-like structure.

5. The dental core and post system as set forth in claim 4, wherein said cage-like structure includes a skin-like outer covering.

6. The dental core and post system as set forth in claim 5, wherein said skin-like outer covering comprises a sleeve.

7. The dental core and post system as set forth in claim 6, wherein said sleeve is removable after fixation.

8. The dental core and post system as set forth in claim 3, wherein said contour or shape of said high density shell is selected from a group consisting of: spherical, spherical half moon, rectilinear, cylindrical, conical, concave, convex, crescent, gibbous, waning gibbous and waxing gibbous.

9. The dental core and post system as set forth in claim 4, wherein said set of interconnected struts or wires formed as said cage-like structure comprise high-density material.

10. The dental core and post system as set forth in claim 3, wherein said high-density shell is configured to receive a low-density material in order to fill said inner volume in vivo at a time of fixation.

11. The dental core and post system as set forth in claim 10, wherein said high-density shell includes a fill port configured to receive a material fill device, the material fill device including a syringe-like extension that is insertable into said fill port.

12. The dental core and post system as set forth in claim 10, wherein said high density shell is configured to vent or release any pressure that can increase in the core device as low-density material is delivered to said inner volume.

13. The dental core and post system as set forth in claim 3, wherein said core device further comprises at least one spline or rib attached to and configured to extend away from said high density shell for fixation to a tooth remainder in order to redirect or redistribute mechanical energy generated by occlusal action away from said dental post.

14. The dental core and post system as set forth in claim 13, wherein said at least one spline extends radially downward away from said central, vertical post axis.

15. The dental core and post system as set forth in claim 13, wherein said at least one spline extends from one of: a top, a central and a lower portion of said core device.

16. The dental core and post system as set forth in claim 13, wherein said high-density shell comprises a cage-like structure of interconnected struts or wires surrounding said inner volume, and wherein said at least one spline extends contiguously from at least one of said interconnected struts or wires.

17. The dental core and post system as set forth in claim 11, wherein said at least one spline comprises a material selected from a group consisting of: metal including metal alloys, stamped metals, including metal alloys, plastics, fiber-reinforced composites and zirconium including zirconium oxides.

18. The dental core and post system as set forth in claim 11, wherein a length of said at least one spline is adjustable to a shape of the residual or remainder tooth structure.

19. The dental core and post system as set forth in claim 1, wherein said dental post comprises said low-density inner volume in one of a coronal portion and an apical portion of said dental post.

20. The dental core and post system as set forth in claim 19, wherein said dental post is configured integrally with said core device, and wherein both said dental post and said core device comprise low-density, inner volumes that are contiguous within the integrally configured device.

21. The dental core and post system as set forth in claim 20, wherein said contiguous low-density inner volume is surrounded by a high-density shell.

22. The dental core and post system as set forth in claim 21, wherein said high density shell includes a port configured to receive a syringe-like extension of a material fill device through which a low-density material is delivered in vivo.

23. The dental core and post system as set forth in claim 22, wherein said high-density shell is configured to vent or release any pressure as low-density material is delivered.

24. The dental core and post system as set forth in claim 20, wherein said dental post and core comprises a cage-like structure.

25. The dental core and post system as set forth in claim 24, wherein said cage-like structure includes an outer covering or skin.

26. The dental core and post system as set forth in claim 25, wherein said outer covering or skin comprises a sleeve.

27. The dental core and post system as set forth in claim 26, wherein said sleeve is configured to be removed after fixation.

28. The dental core and post system as set forth in claim 19, wherein said low-density inner volume is configured to be filled with a low-density material in vivo at fixation.

29. The dental core and post system as set forth in claim 24, wherein said cage-like structure is configured to contact a residual tooth portion and redirect mechanical forces traveling substantially downward away from said central, vertical post axis.

30. The dental core and post system as set forth in claim 19, wherein rod-like member is cylindrical, and includes at least one via through a surface of the cylindrical rod-like member to facilitate communication from and out of said inner volume to any available canal space.

31. The dental core and post system as set forth in claim 30, wherein said low-density material is a cement to implement said fixation.

32. A dental core system comprising a core device including an inner, low-density volume bisected by a central vertical axis and configured for attachment to a coronal end of a dental post such that the central vertical axis of the core device aligns with a central vertical axis of the dental post and upon fixation of the dental post thereto operates to interrupt or redistribute occlusal forces and energy away from the dental post.

33. The dental core system as set forth in claim 32, wherein said core device comprises a cage-like structure in a form of a high-density shell that defines a shape of the inner, low-density volume.

34. The dental core system as set forth in claim 33, wherein said cage-like structure includes an outer covering or skin surrounding said inner, low density volume, in contact with or standing off from an outer surface comprising said cage-like structure.

35. The dental core system as set forth in claim 34, wherein said outer covering or skin is configured to be removable after attachment of the cage-like structure to a dental post.

36. The dental core system as set forth in claim 34, wherein said inner volume or skin is configured to be filled in vivo with a low-density material.

37. The dental core system as set forth in claim 34, wherein a space formed between said outer surface of said cage-like structure that is configured to be filled with said low-density material and forms a flashing against an outer surface of said cage-like structure upon setting.

38. The dental core system as set forth in claim 36, wherein said core device includes a port configured to receive a syringe-like extension or a material fill device and receive said low-density material.

39. The dental core system as set forth in claim 38, wherein said core device is configured to vent or release any pressure generated by delivery of the low-density material.

40. The dental core system as set forth in claim 32, wherein said core device comprises a high-density shell configured in a shape of the low-density volume.

41. The dental core system as set forth in claim 40, wherein said core device further comprises at least one spline extending from the high-density shell.

42. The dental core system as set forth in claim 33, wherein said core device further comprises a ring-like structure configured to be connected to said dental post, wherein a radius of said ring-like structure is configured to be adjustable to fix the ring-like structure to the remaining tooth shape.

43. The dental core system as set forth in claim 33, wherein said core device comprises an extension extending from a side thereof configured for insertable connection within a complementary opening or slot in a top or side of a coronal end of a dental post upon in vivo fixation.

44. The dental core system as set forth in claim 33, wherein said core device comprises a cage-like structure configured with means to facilitate in vivo adjustment of a footprint or apical circumference of the cage-like structure intended to contact a tooth remainder.

45. The dental core system as set forth in claim 44, wherein said cage-like structure comprises struts or wires configured to move and slide to adjust said footprint or apical circumference in vivo to accommodate dimensions of said tooth remainder.

46. The dental core system as set forth in claim 44, wherein said cage structure comprises struts or wires configured to move or slide and thereby adjusts the height and width and therefore an inner volume of the core device.

47. The dental core system as set forth in claim 46, wherein said cage structure further comprises a rotational screw-like device which contacts with the struts or wires and as turned in either rotational direction, causes the struts or wires to move or slide about each other to extend or contract respective lengths thereby adjusting the height, width and volume of the core device.

48. A dental core system comprising a core device comprising at least one spline having a first spline end and a second spline end and configured for in vivo attachment to a dental post affixed within a root canal of a tooth under restoration at the first spline end, and attachment to a tooth remainder at the second spline end in order to interrupt or redistribute mechanical energy generated by occlusal forces away from a central vertical axis of the dental post subsequent to said in vivo attachments.

49. The dental core system as set forth in claim 48, wherein said at least spline is configured to extend at an acute angle downwardly with respect to said central vertical axis subsequent to said in vivo attachments.

50. The dental core system as set forth in claim 49, wherein said core device comprises two or more splines are configured for positioning at radial offsets to each other about a circumference of said dental post subsequent to said in vivo attachments.

51. The dental core system as set forth in claim 50, wherein said two or more splines are configured to function as ribs in an umbrella-like structure subsequent to said in vivo attachments.

52. The dental core system as set forth in claim 51, wherein a length of said splines is adjustable prior to said in vivo attachment of said second spline end.

53. The dental post system as set forth in claim 48, wherein said at least one spline comprises a material selected from a group consisting of: metal including metal alloys, stamped metals, including metal alloys, plastics, fiber-based composites and zirconium including zirconium oxides.

54. The dental core and post system as set forth in claim 1, wherein the core device includes an attachment means configured with a cylindrical portion to slide over and couple to the coronal end of the dental post in vivo.

55. The dental core and post system as set forth in claim 54, wherein the cylindrical portion of the attachment means is configured as a crimpable cylindrical shell in order to securely couple the core device to a coronal end of the dental post.

56. The dental core and post system as set forth in claim 19, wherein the core device includes attachment means having a crimpable cylindrical portion configured to slide over the coronal end of the dental post in vivo, coupling the core device and dental post, wherein the attachment means includes at least one through hole in a side or apical center to allow for low density material or adhesive to flow through and envelop the dental post or flow into an opening or inner volume a dental post.

57. The dental core system as set forth in claim 32, wherein the core device includes attachment means configured with a cylindrical portion to slide over and couple the core device to a coronal end of a dental post in vivo.

58. The dental core system as set forth in claim 57, wherein the cylindrical portion of the attachment means is configured as a crimpable cylindrical shell in order to enable a dental practitioner to crimp and securely attach the core device to a coronal end of the dental post.

59. The dental core system as set forth in claim 32, wherein the core device includes attachment means having a crimpable cylindrical portion configured to slide over the coronal end of the dental post in vivo, coupling the core device and dental post, wherein the attachment means includes at least one through hole in a side or apical center to allow for low density material or adhesive to flow through and envelop the dental post or flow into an opening or inner volume a dental post.

60. The dental core system as set forth in claim 48, wherein the core device includes attachment means to which the at least one spline is attached, the attachment means configured with a cylindrical portion to slide over a coronal end of a dental post and couple the core device thereto.

61. The dental core system as set forth in claim 57, wherein the cylindrical portion of the attachment means is configured as a crimpable cylindrical shell in order to enable a dental practitioner to crimp and securely attach the core device to a coronal end of the dental post.

62. The dental core and post system as set forth in claim 54, wherein the attachment means is configured such that an inside diameter of the cylindrical portion displays a slight taper to mate with a coronal portion of the dental post.

63. The dental core and post system as set forth in claim 57, wherein the attachment means is configured such that an inside diameter of the cylindrical portion displays a slight taper to mate with a coronal portion of a dental post at fixation.

64. The dental core and post system as set forth in claim 60, wherein the attachment means is configured such that an inside diameter of the cylindrical portion displays a slight taper to mate with a coronal portion of a dental post at fixation.

65. The dental core and post system as set forth in claim 1, further comprising attachment means configured to be fixed to the core device at one end and fixed to the dental post at its other end, wherein the end configured for fixing to the dental post is cylindrical and displays a slight taper in order that it receive and mate with a coronal end of the dental post.

66. The dental core and post system as set forth in claim 32, further comprising attachment means configured to be fixed to the core device at one end and to be fixed to a dental post at its other end, wherein the end configured for fixing to the dental post is cylindrical and displays a slight taper in order that it receive and mate with a coronal end of the dental post.

67. The dental core and post system as set forth in claim 1, further comprising attachment means configured to be fixed to the core device at one end and to be fixed to a dental post at its other end, wherein the end configured for fixing to the dental post is cylindrical and displays a slight taper in order that it receive and mate with a coronal end of the dental post.
